(19) United States
(12) Patent Application Publication
(10) Pub. No.: US 2024/0411697 A1
(43) Pub. Date: Dec. 12, 2024

(54) UPDATING A CACHE IN A MULTI-LAYER DATA STORE USING PARALLEL PREFETCH THREADS

(71) Applicant: VMware LLC, Palo Alto, CA (US)

(72) Inventors: Wenguang WANG, Santa Clara, CA (US); Quanxing LIU, Mountain View, CA (US); Matthew B. AMDUR, Winchester, MA (US); Pascal RENAULD, Palo Alto, CA (US); Eric KNAUFT, San Francisco, CA (US)

(21) Appl. No.: 18/329,577

(22) Filed: Jun. 6, 2023

(51) Int. Cl. G06F 12/0862; G06F 12/0831

(52) U.S. Cl. CPC G06F 12/0862; G06F 12/0833; G06F 2212/7201

(57) ABSTRACT

The disclosure herein describes managing write requests in a multi-layer data store using prefetch threads. Prefetch requests received at the multi-layer data store are added to a prefetch request queue. A first prefetch thread obtains a first prefetch request and a second prefetch thread obtains a second prefetch request from the prefetch request queue. A memory cache is updated with first metadata of the first prefetch request by the first prefetch thread and with second metadata of the second prefetch request by the second prefetch thread, in parallel. After the memory cache is updated, a data bank in memory reaches a flush threshold and data in the data bank is written to a second data store, wherein the first metadata and second metadata in the memory cache are used to update a metadata structure with respect to the data written to the second data store.

### BACKGROUND

In a distributed storage system, it is necessary to carefully organize input-output (I/O) operations to ensure efficient operation of the system overall. Often, memory caches are used to streamline the performance of I/O operations in such distributed storage systems. In the event of an operation attempting to access data that is not present in a memory cache, the scheduled I/O operations of the system are interrupted and/or delayed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for managing write requests in a multi-layer data store using a prefetch module and associated prefetch threads. Prefetch requests received at the multi-layer data store are added to a prefetch request queue. A first prefetch thread obtains a first prefetch request of the prefetch requests in the prefetch request queue and a second prefetch thread obtains a second prefetch request of the prefetch requests in the prefetch request queue. A memory cache is updated with first metadata associated with a first logical block address (LBA) of the first prefetch request from a first data store by the first prefetch thread. Further, the memory cache is updated with second metadata associated with a second LBA of the second prefetch request from the first data store by the second prefetch thread. The updating of the memory cache by the first prefetch thread and by the second prefetch thread are performed in parallel. After the memory cache is updated, a data bank associated with the memory cache is determined to have reached a flush threshold and, based on reaching that flush threshold, data in the data bank is written to a second data store. Because the first metadata and second metadata have already been added to the updated memory cache, it is determined that the first metadata and second metadata in the memory cache are up to date with respect to the data written to the second data store, such that no further metadata reads from the performance data store are needed during the flush process. A metadata structure of the first data store is then updated using the first metadata and second metadata in the memory cache, wherein the updated metadata structure indicates data locations in the second data store to which the data associated with the first prefetch request and the second prefetch request was written.

### BRIEF DESCRIPTION OF THE DRAWINGS

The present description will be better understood from the following detailed description read in light of the accompanying drawings, wherein:

FIG. 1 is a block diagram illustrating an example system that is comprised of a set of compute nodes interconnected with each other and a set of storage nodes;

FIG. 2 is a block diagram illustrating an example system for managing write requests in a multi-layer data store and using a prefetch module and associated prefetch threads;

FIG. 3 is a sequence diagram illustrating an example process of managing write requests in a multi-layer data store using a prefetch module and an associated prefetch thread;

FIG. 4 is a sequence diagram illustrating an example process of processing prefetch requests in parallel using multiple prefetch threads;

FIG. 5 is a flowchart illustrating an example method for storing data of write requests in a multi-layer data store using a prefetch module and associated prefetch threads;

FIG. 6 is a flowchart illustrating an example method for prefetching data to a memory cache by a prefetch thread; and

FIG. 7 illustrates an example computing apparatus as a functional block diagram.

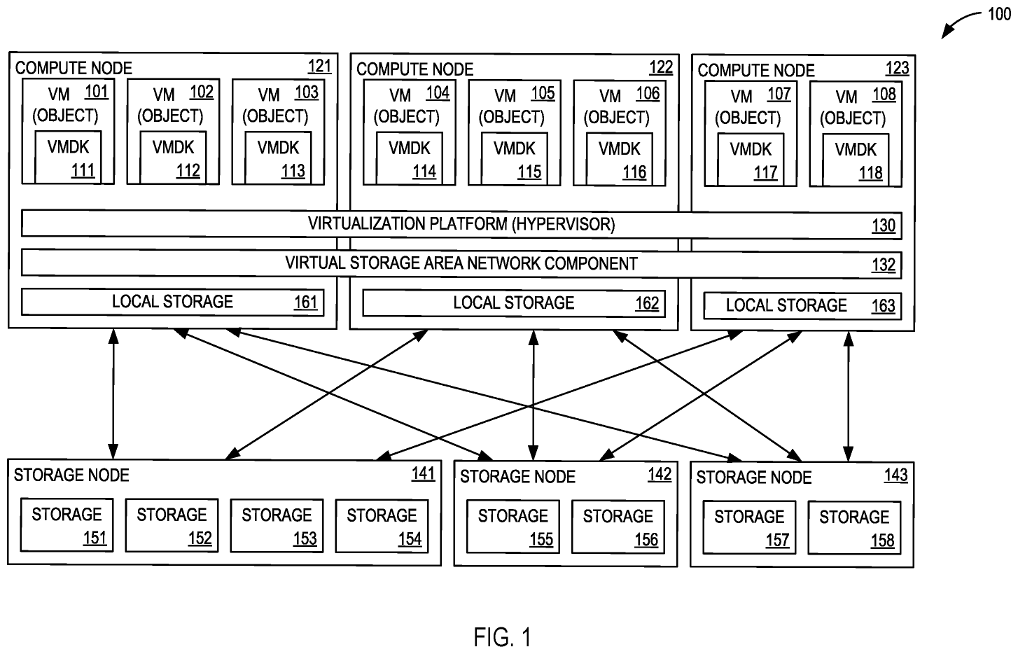

Corresponding reference characters indicate corresponding parts throughout the drawings. In FIGS. 1 to 7, the systems are illustrated as schematic drawings. The drawings may not be to scale. Any of the drawings may be combined into a single example or embodiment.

### DETAILED DESCRIPTION

Aspects of the disclosure provide a computerized method and system for managing write requests and an associated memory cache in a multi-layer data store using a prefetch module and associated prefetch threads. The disclosure records and stores data using a first and second data store. The first data store is relatively small and used to organize and temporarily store data and associated metadata associated with write requests. The second data store is relatively large and used to more permanently store data and/or associated changes to data addresses within the system. As part of the process of storing data in this multi-layer data store, data associated with write requests is built up in the first data store until it reaches a flush threshold and then the built-up data of the write requests is written to the second data store in a large batch write operation called a “bank flush” operation. The bank flush operation writes data from a data bank associated with the first data store to the second data store whenever possible. Performing I/O operations to update the memory cache of the first data store with metadata associated with the data in the data bank during the bank flush operation is significantly slower and it delays the entire bank flush operation. The prefetch module and associated prefetch threads are used to obtain metadata from the first data store and update the memory cache with the obtained metadata in parallel to other operations being done with respect to the first data store. The prefetch threads also operate in parallel with each other, providing a higher likelihood that all the metadata needed for a bank flush operation is present in the memory cache. Thus, the prefetch module and associated prefetch threads reduce or eliminate the occurrence of cache misses during a bank flush operation, improving the rate and efficiency with which bank flush operations can be completed. For example, the disclosure reduces or eliminates the need for performing I/O operations to retrieve metadata from the first data store during the bank flush process.

The disclosure operates in an unconventional manner at least by enabling the memory cache to be updated by multiple prefetch threads in parallel to each other and to other operations that are being performed with respect to the multi-layer data store. The use of such parallel processing threads provides increased capacity by which caching operations can be performed. Further, that increased capacity can be dynamically adjusted by changing the quantity of active prefetch threads. Thus, the disclosure enables systems to decrease the likelihood of cache misses during a bank flush operation, thereby increasing the efficiency with which such operations are performed and saving time and system resources that are wasted during the handling of cache misses. Additionally, the disclosure enables systems to control the quantity of active prefetch threads that are used, such that the quantity of resources spent on managing and executing prefetch threads can be reduced to a minimum amount required to avoid the cache misses described above.

Further, the disclosure describes a method by which prefetch threads enable highly granular parallel performance of prefetch caching operations. In some examples, a prefetch thread identifies a metadata block associated with a prefetch request that is not present in the memory cache. The prefetch thread modifies its current prefetch request to remove the address associated with the identified metadata block and then requeues the modified prefetch request in the queue of the prefetch module, such that another prefetch thread is enabled to obtain and continue processing that modified prefetch request. Through such behavior, the prefetch threads reduce or eliminate the chance of a prefetch thread waiting for a request to process while another thread has a request that it cannot continue processing during I/O operations to cache a metadata block. This feature further increases the efficiency of the prefetch caching processes and reduces waste of system resources associated therewith.

FIG. 1 is a block diagram illustrating a system 100 that is comprised of a set of compute nodes 121-123 interconnected with each other and a set of storage nodes 141-143 according to an embodiment. In other examples, a different number of compute nodes and storage nodes are used without departing from the description. Each compute node hosts multiple objects, which are virtual machines (VMs), containers, applications, and/or any compute entity that can consume storage, in some examples. When objects are created, they are designated as global or local, and the designation is stored in an attribute. For example, compute node 121 hosts objects 101, 102, and 103; compute node 122 hosts objects 104, 105, and 106; and compute node 123 hosts objects 107 and 108. Some of objects 101-108 are local objects. In some examples, a single compute node hosts 50, 100, or a different number of objects. Each object uses a virtual machine disk (VMDK). For example, VMDKs 111-118 are used by objects 101-108, respectively. Other implementations using different formats are also possible. A virtualization platform 130, which includes hypervisor functionality at one or more of computer nodes 121, 122, and 123, manages objects 101-108.

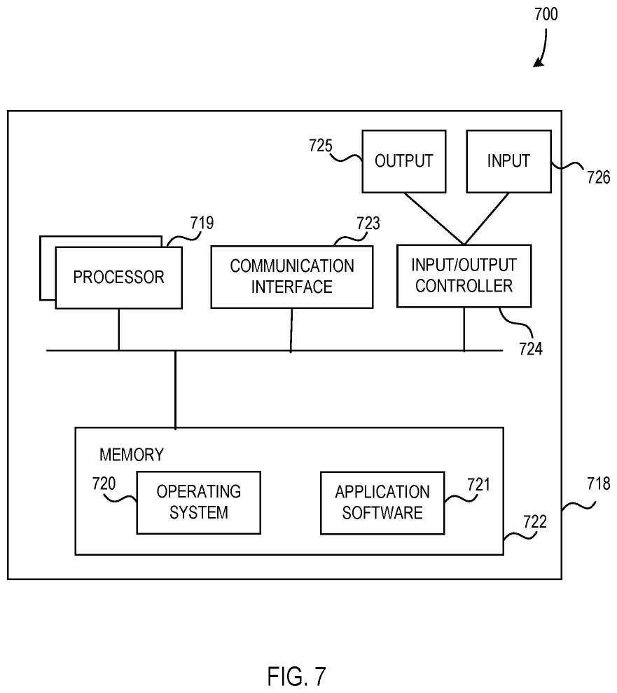

In some examples, various components of system 100, for example compute nodes 121, 122, and 123, and storage nodes 141, 142, and 143 are implemented using one or more computing apparatuses 718 of FIG. 7.

Virtualization software provides software-defined storage (SDS) by pooling storage nodes across a cluster, creates a distributed, shared data store (e.g., a storage area network (SAN)). In some examples with distributed arrangements, servers are distinguished as compute nodes (e.g., compute nodes 121, 122, and 123) and storage nodes (e.g., storage nodes 141, 142, and 143). In such examples, storage nodes attach large quantities of storage devices (e.g., flash, solid state drives (SSDs) and non-volatile memory express (NVMe) and Persistent Memory (PMEM)) processing power are limited beyond the ability to handle input/output (I/O) traffic. For example, storage node 141 has storage 151, 152, 153, and 154; storage node 142 has storage 155 and 156; and storage node 143 has storage 157 and 158. In other examples, a single storage node includes a different number of physical storage components without departing from the description. In the described examples, storage nodes 141-143 are treated as a SAN with a single global object, enabling any of objects 101-108 to write to and read from any of storage 151-158 using a virtual SAN component 132. Virtual SAN component 132 executes in compute nodes 121-123.

In some examples, thin provisioning is used and storage nodes 141-143 do not require significantly more processing power than is needed for handling I/O traffic. This arrangement is less expensive than many alternative hyperconverged environments in which all of storage nodes 141-143 have the same or similar processing capability as compute node 121. Using the disclosure, compute nodes 121-123 can operate with a wide range of storage options.

In some examples, compute nodes 121-123 each include a manifestation of virtualization platform 130 and virtual SAN component 132. Virtualization platform 130 manages the generating, operations, and clean-up of objects 101 and 102, including the moving of object 101 from compute node 121 to another compute node, to become a moved object. For example, virtual SAN component 132 permits objects 101 and 102 to write incoming data from object 101 and incoming data from object 102 to storage nodes 141, 142, and/or 143, in part, by virtualizing the physical storage components of the storage nodes. Further, in some examples, the compute nodes 121, 122, and 123 include and make use of local storage nodes 161, 162, and 163, respectively, for storing some data used during the operation of the system 100 without departing from the description.

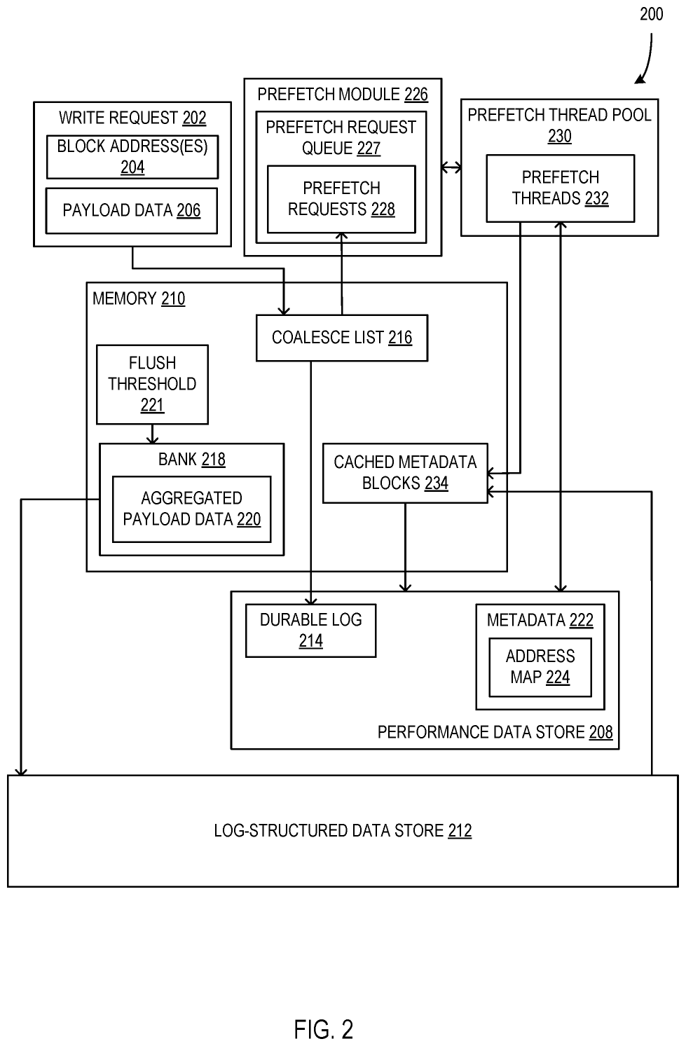

FIG. 2 is a block diagram illustrating a system 200 for managing write requests 202 in a multi-layer data store 208 and 212 using a prefetch module 226 and associated prefetch thread pool 230. In some examples, the system 200 includes or is otherwise associated with a system such as system 100 of FIG. 1. In some examples, the multi-layer data store 208 and 212 is used as part of a storage node and/or storage of such a system (e.g., storage nodes 141-143 and/or storage 151-158 or local storage 161-163).

The system 200 includes a performance data store 208, a memory 210, and a log-structured data store 212 that are configured to store payload data 206 that are provided by write requests 202. The performance data store 208 and memory 210 are used to temporarily store the data of the write requests 202 until a sufficient quantity of data is received and then, the data is written as a batch to the log structure data store 212 for more permanent storage.

The write requests 202 include one or more block addresses 204 and associated payload data 206. In some examples, the block addresses 204 are logical block addresses (LBAs) that represent address locations to which the payload data 206 is to be written in the address space of the system 200. For example, a write request 202 is provided to the system 200 that includes a first block address 204 indicating a first address location in the address space and an associated first set of payload data 206 and a second block address 204 indicating a second address location in the address space and an associated second set of payload data 206. The first set of payload data 206 is written to the first address location of the address space and the second set of payload data 206 is written to the second address location of the address space because of the processes of the system as described herein.

Write requests 202 are received by the system 200 and initially stored in the memory 210. The memory 210 stores a received write request 202 in a coalesce list 216. Multiple write requests are added to the coalesce list 216 and, after reaching a defined threshold, the coalesce list 216 is considered full and is processed. The processing includes the generation or construction of a prefetch request 228 using the LBA extents of the write requests 202 in the coalesce list 216 and the posting of the prefetch request 228 to the prefetch module 227. Further, the full coalesce list 216 is added to an in-memory durable log queue from which the data of the write requests 202 will be persisted into the on-disk durable log 214 in the performance data store 208. A durable log handler process operates in the background to retrieve the coalesce lists 216 from the durable log queue to add them to the durable log 214. After this processing is complete, the data of the write requests 202 in the coalesce list 216 is written to the bank 218 data structure in memory 210, including the payload data 206 of write requests 202 being stored as aggregated payload data 220 in the bank 218. Additionally, in some examples, after a coalesce list 216 becomes full and is processed, another coalesce list 216 is created and new write requests 202 are added thereto.

The bank 218 has an associated flush threshold 221. When the quantity of stored data in the bank 218 reaches and/or exceeds the flush threshold 221, the system 200 performs a “bank flush”, in which the aggregated payload data 220 of write requests 202 is written to the log-structure data store 212 as a batch. In some examples, the flush threshold 221 is a defined quantity of data. Alternatively, or additionally, the flush threshold 221 is a percentage value of a capacity of the bank 218.

The described I/O process includes caching metadata blocks 234 in a memory 210 during the period in which the bank 218 is being populated with data of write requests 202. Metadata associated with the data that is flushed from the bank 218 to the log-structure data store 212 during a bank flush process is cached as cached metadata blocks 234 in the memory 210 to improve the rate at which the bank flush operation can be completed. In some examples, the data blocks of the aggregated payload data 220 are written to the log-structured data store 212 as a full stripe write and/or using “append-only” data storage techniques that are associated with log-structured data storage generally. For example, newly written data is appended to the log-structured data store 212 at the end of the most recently written data and then referenced by address rather that rearranging data already written on the log-structured data store 212 to conform to a different type of data arrangement, thereby avoiding expensive processes to move data around within the data store.

Further, the bank flush process includes updating the address map 224 in the metadata 222 based on the locations in which data blocks referenced by the cached metadata blocks 234 are written in the log-structured data store 212. The address map 224 includes mappings from LBAs to middle block addresses (MBAs) and mappings from MB As to physical block addresses (PBAs) (e.g., addresses of block locations of data blocks written to the log-structured data storage 212). The address map 224 includes two tree structures, a logical tree and a middle tree. The logical tree includes mappings from LBAs to MBAs and the middle tree includes mappings from MBAs to PBAs. MBAs are addresses in a “middle address space” which is used as a temporary address space between the logical address space of LBAs and the physical address space of PBAs. The MBAs can be reallocated and/or reused during the operations of the system 200 as necessary. In some examples, after the data blocks of the aggregated payload data 220 are written to the log-structured data store 212, the address map 224 is updated to include the metadata in the cached metadata blocks 234. This metadata includes references that map from LBAs of payload data to MBAs and references that map those MBAs to PBAs of data blocks in the log-structured data store 212. Additionally, or alternatively, in some examples, the address map 224 includes mappings from LBAs associated with write requests 202 to PBAs of data blocks in the log-structured data store 212 without departing from the description.

The system 200 includes a prefetch module 226 and an associated prefetch thread pool 230 of prefetch threads 232. The prefetch module 226 includes hardware, firmware, and/or software configured to store and manage prefetch requests 228 in a prefetch request queue 227, while the prefetch threads 232 of the prefetch thread pool 230 are configured to obtain prefetch requests 228 from the prefetch module 226 and to record metadata associated with write requests 202 from the performance data store 208 as cached metadata blocks 234 in preparation for performing a bank flush to write aggregated payload data 220 of those write requests 202 from the bank 218 in memory 210 to the log-structure data store 212.

In some examples, the prefetch requests 228 include the LBA extents of the write requests 202 and are obtained from the coalesce list 216. A prefetch request 228 can include LBA extents from one or more write requests 202. The prefetch module 226 queues prefetch requests 228 in the prefetch request queue 227 during the period prior to a bank flush process and, as more write requests 202 arrive at the coalesce list 216 and that coalesce list 216 becomes full, the LBA extents of those write requests 202 are also provided to or obtained by the prefetch module 226 for queuing as one or more prefetch requests 228.

Further, in some examples, the prefetch requests 228 include one or more LBA extents (e.g., associated with one or more write requests 202) associated with data blocks that are to be written to the log-structured data store 212. A prefetch thread 232 is an application, program, or script configured to obtain a prefetch request 228 from the prefetch module 226 and then determine whether metadata blocks associated with the LBAs of the obtained prefetch request 228 are present in the cached metadata blocks 234 of the memory 210. If the prefetch thread 232 identifies an LBA for which a metadata block is not present in the cached metadata blocks 234, the prefetch thread 232 performs I/O operations to obtain the metadata block associated with the identified LBA and to write the obtained metadata block to the cached metadata blocks 234 of the memory 210. In such examples, the prefetch thread 232 searches for all the LBAs of a prefetch request 228 and writes any missing metadata blocks to the cached metadata blocks 234 based on those searched LBAs. It should be understood that the cached metadata blocks 234 include metadata associated with specific LBAs and/or LBA extents (e.g., groups of continuous addresses). In some examples, cached metadata blocks 234 include mapping metadata such as the data stored in the address map 224 as described above. Metadata associated with an LBA or extent of LBAs can include multiple metadata pages that describe mappings between the LBA and MBAs and between MBAs and PBAs without departing from the description.

It should be understood that the prefetch threads 232 are configured to perform the described operations in parallel with each other. Therefore, several prefetch requests 228 are processed simultaneously to quickly and efficiently cache the metadata blocks that are needed for an upcoming bank flush to the log-structured data store 212. Additionally, or alternatively, in some examples, the prefetch threads 232 are configured to enable further parallelism. In such examples, a prefetch thread 232 that has identified an LBA for which a metadata block is missing from the cached metadata blocks 234 is configured to add a prefetch request 228 to the prefetch request queue 227 of the prefetch module 226 that includes any LBAs that remain to be searched from the prefetch request 228 currently being processed by the prefetch thread 232. As a result, as the prefetch thread 232 performs the I/O operations necessary to cache the missing metadata block(s) associated with the identified LBA, another prefetch thread 232 can obtain the new prefetch request 228 and continue searching and/or otherwise processing the LBAs therein.

Additionally, or alternatively, prefetch threads 232 are configured to make use of asynchronous I/O operation processing. For example, a prefetch thread 232 identifies three different LBAs for which metadata must be retrieved and cached. The prefetch thread 232 is configured to initiate three I/O operations to retrieve the metadata of the three LBAs, wherein the prefetch thread 232 initiates a second I/O operation to retrieve the metadata of one of the three LBAs prior to receiving a response from the first I/O operation to retrieve the metadata of another one of the three LBAs. Thus, the prefetch thread 232 streamlines the process of retrieving the metadata of the LBAs by reducing the time spent waiting for responses to I/O operations.

In some examples, the bank flush process of writing the data blocks of the aggregated payload data 220 from the bank 218 to the log-structured data store 212 is single-threaded and involves reading multiple data blocks from the bank 218 in the memory 210 associated with the performance data store 208. Because it is single-threaded, a cache miss during the update of the address map 224 in the metadata 222 causes a significant delay in the performance of the bank flush due to the need to perform I/O operations to obtain the missing metadata block from non-cache storage, which is a relatively slow process compared to reading metadata from the memory 210. A cache miss occurs, for example, when metadata associated with an LBA is to be used in the address map 224 but the associated metadata block is not present in the cached metadata blocks 234. However, because the prefetch module 226 and prefetch threads 232 operate together as described herein to cache the metadata blocks for a bank flush using parallel threads 232, the caching of those metadata blocks is likely to be complete prior to the initiation of the bank flush process.

Further, in some examples, the system 200 is configured to use historical patterns of behavior to determine when to use the prefetch module 226 and associated prefetch threads 232 and/or to what degree to use them to populate the memory 210. For instance, patterns of high quantities of write requests and/or low quantities of write requests are observed and then rules controlling the prefetch processes are defined based on those observed patterns. In an example, higher quantities of write requests are observed during an hour-long period each day and a prefetch rule is defined that results in the prefetch module 226 and a particular quantity of prefetch threads 232 being activated during that period. Alternatively, low quantities of write requests are observed during another period each day and a second prefetch rule is defined that results in the quantity of active prefetch threads 232 being reduced and/or the deactivation of the prefetch module 226 entirely during that period. Such rules can be used to reduce resources used by the prefetch processes during periods when they are less needed while ensuring that there is sufficient prefetch capacity during periods when they are more needed.

In some examples, the system 200 is configured to use machine learning techniques to automatically make decisions about how the prefetch module 226 and the associated prefetch threads 232 operate. For example, a model is trained using machine learning techniques to decide when to begin prefetching data using the prefetch module 226 and associated prefetch threads 232 and/or to decide how many prefetch threads 232 to use to cache data in the memory 210. The model is trained to take a current quantity of data stored in the bank 218, a current number of active prefetch threads 232, and/or other related data as input and generate an indication of whether another prefetch thread 232 should be initiated or whether an active prefetch thread 232 should be halted. The model is trained to minimize the use of system resources by prefetch threads 232 while ensuring that there is a very high likelihood that all the necessary metadata is cached in the memory 210 when the next bank flush process occurs. In such examples, the model evaluates the current state of the system periodically (e.g., several times per second) such that the quantity of active prefetch threads 232 is dynamically adjusted during operation of the system 200. Further, in some examples, the model is trained over time while it is being used, wherein adjustments are made to the model based on whether there is data missing from the memory 210 when the next bank flush process begins and/or whether the caching of metadata in the memory 210 is finished prior to the next bank flush process beginning by a significant margin. Such a model is trained using deep learning classification algorithms and/or other machine learning techniques without departing from the description. As a result of such training, the model is configured to detect patterns in the behavior of the system 200 and increase or decrease the rate of prefetching in response to those patterns.

Additionally, or alternatively, in some examples, a trained machine learning model is used to predict or determine what metadata to prefetch based on patterns of LBAs that are in prefetch requests 222. For instance, in an example, if a prefetch request 222 includes LBAs 1, 2, 3, 4, and 5, a trained machine learning model detects a pattern of LBAs and determines that metadata associated with LBA 6, 7, and/or more LBAs in the pattern should be prefetched. By using a model that can accurately predict what metadata should be prefetched, the parallelism of the prefetch module 226 and prefetch threads 232 can better be used to efficiently update the memory 210 with cached metadata blocks 234.

In some examples, the trained model of the system 200 includes a machine learning module that comprises a trained regressor such as a random decision forest, a directed acyclic graph, a support vector machine, a convolutional neural network or other neural network, or another trained regressor. Such a trained regressor may be trained using the timing data associated with bank flush processes as feedback data. It should further be understood that the machine learning module, in some examples, operates according to machine learning principles and/or techniques without departing from the systems and/or methods described herein.

In an example, the machine learning model of the system 200 makes use of training data pairs when applying machine learning techniques and/or algorithms. Millions of training data pairs (or more) may be stored in a machine learning data structure. In some examples, a training data pair includes a system state data set paired with an indication of whether the caching of data through prefetching was completed prior to the start of a bank flush process. The pairing of the two values demonstrates a relationship between the feedback data value and the adjustment values that may be used by the machine learning model to determine future interval adjustments according to machine learning techniques and/or algorithms.

It should be understood that, while in most examples herein, the aggregated payload data 220 is being written to a log-structured data store during a bank flush process, the use of the described prefetch processes are not limited to use in systems with log-structured data stores. Any system that includes logging of data, accumulation of quantities of data, and then flushing of that accumulated data in batches to a data store of any kind can make use of the described prefetch module 226 and associated prefetch threads 232 to take advantage of parallelism to cache the metadata that will be used during an upcoming batch flush process.

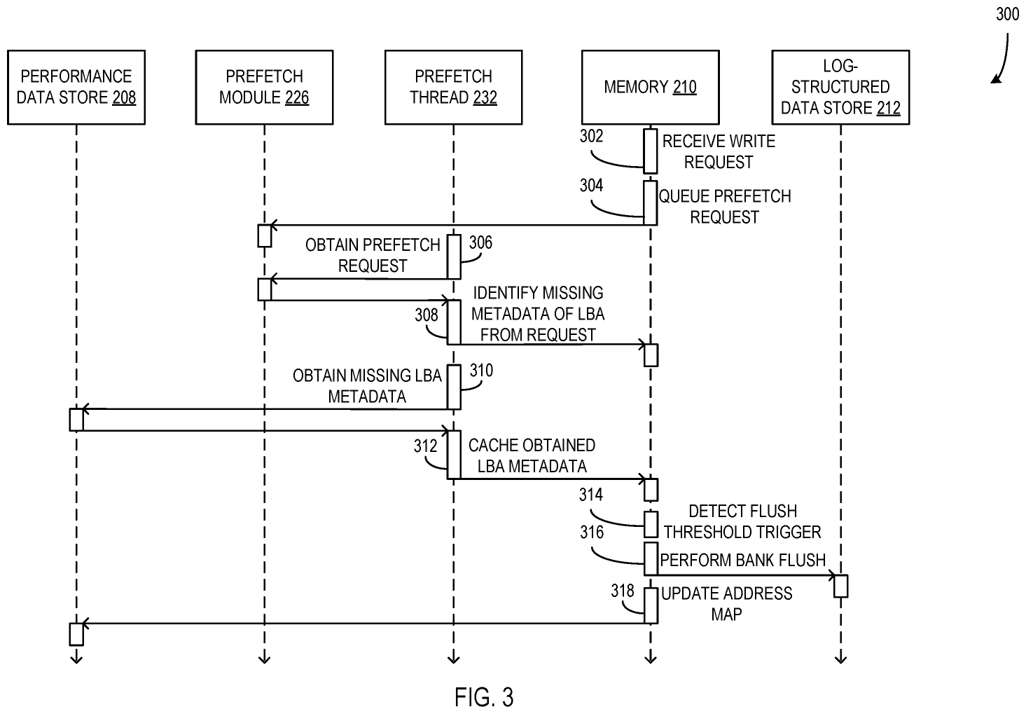

FIG. 3 is a sequence diagram illustrating a process 300 of managing write requests (e.g., write request 202) in a multi-layer data store using a prefetch module 226 and an associated prefetch thread 232. In some examples, the process 300 is executed or otherwise performed in or in association with systems such as system 100 of FIG. 1 and/or system 200 of FIG. 2.

At 302, a write request is received at a coalesce list 216 of the memory 210. In some examples, adding the received write request to the coalesce list 216 further causes the requests in the coalesce list 216 to be written to the bank 218 in memory 210 associated with the performance data store 208, where the payload data of write requests are recorded as aggregate payload data 220, as described herein.

At 304, a prefetch request 228 is queued to the prefetch module 226 from the coalesce list 216. In some examples, queuing the prefetch request includes adding the LBA extents of the write requests in the coalesce list 216 to a prefetch request 228 and queuing the prefetch request 228 in the prefetch request queue 227 prefetch module 226.

At 306, a prefetch thread 232 associated with the prefetch module 226 obtains a prefetch request from the prefetch module 226. In some examples, the obtained prefetch request includes LBA extents of data of the write request received at 302 and of other write requests as described above. Further, the LBA extents of the obtained prefetch request includes at least one LBA associated with a data block to which data is to be written based on at least one of the write requests that is represented in the obtained prefetch request. For example, the obtained prefetch request includes LBA extents from a first write request and a second write request. The LBA extents of the first write request include an LBA of X for a data block X and the LBA extents of the second write request include an LBA of Y for a data block Y.

At 308, the prefetch thread 232 identifies missing metadata associated with a LBA from the prefetch request in the memory 210. For example, metadata that includes maps from the LBA to other addresses is not currently present in the memory 210. In some examples, the prefetch thread 232 reads the memory 210 to find metadata of LBAs that is present in the obtained prefetch request. If metadata of an LBA from the obtained prefetch request is present in the memory 210, then the prefetch thread 232 does not perform any further I/O operations.

However, when, at 308, missing metadata of a LBA is identified based on reading the memory 210, the prefetch thread 232 is configured to perform I/O operations to obtain the missing LBA metadata at 310. In some examples, obtaining the missing LBA metadata at 310 includes accessing mapping metadata associated with the LBA in the performance data store 208 and/or log-structured data store 212, and then recording the accessed metadata and the associated LBA to the memory 210, such that the obtained LBA metadata is cached at 312.

Later, at 314, a flush threshold trigger is detected and, as a result of this detection, a bank flush is performed at 316. In some examples, the flush threshold is based on a quantity of write requests stored in the bank 218 in memory 210 that are queued for writing to the log-structured data store 212. Alternatively, or additionally, the flush threshold is based on a quantity of data stored (e.g., a flush threshold at 512 Kilobytes (KB) of data) in the bank or a percentage of the total data capacity of the bank occupied by write request data (e.g., a flush threshold at 90% of a total data capacity of the bank). It should be understood that, in some examples, detection of the flush threshold trigger at 314 only occurs after multiple write requests have been received at the performance data store 208, such that the performance of 302-312 occurs multiple times prior to 314 being performed. For example, the prefetch thread 232 obtains multiple prefetch requests and caches metadata blocks associated with LBAs to the memory 210 multiple times before the flush threshold of the performance data store 208 is triggered at 314.

At 316, the bank flush is performed by writing the data stored in the bank 218 to the log-structured data store 212. In some examples, writing the data in the bank 218 to the log-structured data store 212 includes writing the data in a batch as a full stripe write to the log-structured data store 212. Further, in some examples, the performance of the bank flush at 316 is done using a single thread, such that the writing of the data in the bank 218 to the log-structured data store 212 is not performed using parallel threads.

At 318, as part of the bank flush operation, the address map 224 of the performance data store 208 is updated with the cached metadata blocks 234 in the memory 210 as described herein. If a cache miss occurs, then costly I/O operations must be performed to obtain the up-to-date metadata, but because the prefetch thread 232 operates to cache the required metadata prior to the bank flush operation, it is unlikely that there will be a cache miss.

In some examples, after the bank flush is performed, the memory 210 is cleared of all metadata associated with data that was written to the log-structured data store 212. Further, the prefetch module 226 is updated to reflect that the metadata associated with the data written to the log-structured data store 212 no longer needs to be cached in the memory 210.

Additionally, or alternatively, generation number values associated with specific bank flushes are used as metadata to manage the processing of the write requests as described herein. A generation number value is assigned to each bank flush and each write request that will be written to the log-structured data store 212 in a bank flush is associated with the generation number value of that bank flush. For instance, a first bank flush is assigned a generation number value of ‘1’ and the bank flush that occurs after the first bank flush is assigned a generation number value of ‘2’. Each write request that is received by the performance data store 208 that will be written to the log-structured data store 212 during the first bank flush is associated with the generation number value of ‘1’ and, after the first bank flush is performed, any prefetch operations for metadata associated with the data written to the log-structured data store 212 during the first bank flush are halted and/or otherwise not performed. This process is then repeated for the next bank flush using the generation number value of ‘2’.

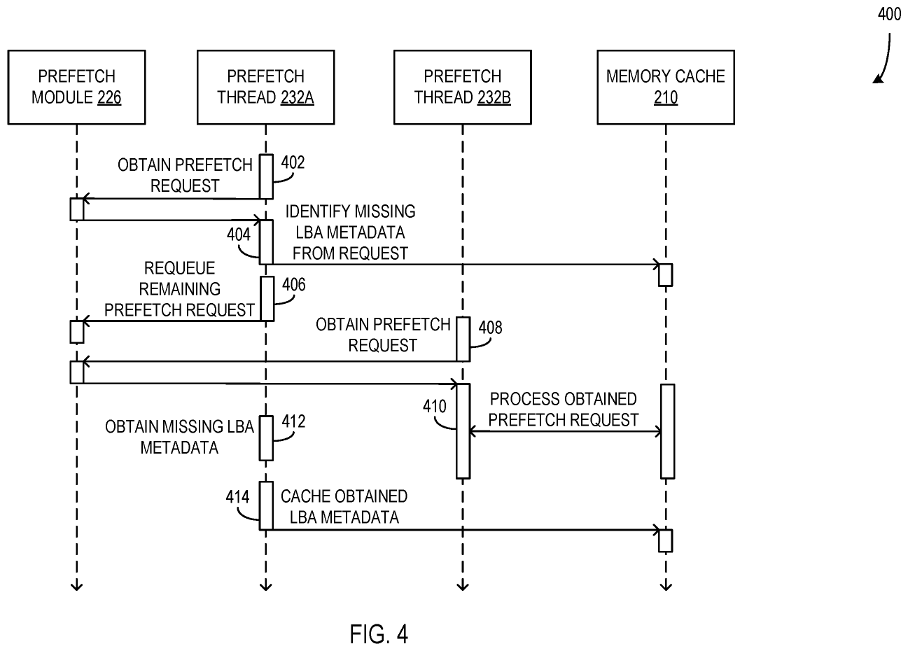

FIG. 4 is a sequence diagram illustrating a process 400 of processing prefetch requests in parallel using multiple prefetch threads 232A and 232B. In some examples, the process 400 is executed or otherwise performed in or in association with systems such as system 100 of FIG. 1 and/or system 200 of FIG. 2. Further, in some examples, the process 400 is performed as part of a process such as process 300 of FIG. 3.

At 402, the prefetch thread 232A obtains a prefetch request from the prefetch module 226. At 404, the prefetch thread 232A identifies missing metadata associated with a LBA from the obtained prefetch request. It should be understood that, in some examples, the prefetch thread 232A is configured to behave as a prefetch thread 232 as described above with respect to at least FIGS. 2 and 3.

At 406, the prefetch thread 232A requeues the remaining prefetch request to the prefetch module 226, wherein the remaining prefetch request 226 does not include the LBA extent for which the missing metadata was just identified by the prefetch thread 232A at 404. For example, the obtained prefetch request includes LBA extents of LBA 1-2, LBA 3, and LBA 4-7. At 404, the prefetch thread 232A identifies that a metadata page associated with the LBA 1-2 extent is missing from the memory 210. At 406, the prefetch thread 232A requeues the remaining prefetch request to the prefetch module 226, wherein the requeued prefetch request includes the LBA extents of LBA 3 and LBA 4-7 but does not include the extent of LBA 1-2. The prefetch thread 232A then proceeds to process the identified LBA 1-2 extent at 412 as described below. In some examples, other metadata pages associated with the LBA 1-2 extent are also determined to be missing from the memory 210 and, in such cases, the prefetch thread 232A also processes those missing metadata pages as well. Thus, other prefetch threads are enabled to continue processing the requeued prefetch request while the prefetch thread 232A processes the identified LBA and associated missing metadata pages at 412 and 414.

At 408, a second prefetch thread 232B obtains a prefetch request from the prefetch module 226 and, at 410, the prefetch thread 232B processes the obtained prefetch request through interactions with the memory 210 and/or the prefetch module 226 as described herein. In some examples, processing the obtained prefetch request at 410 includes reading LBAs and associated metadata in the memory 210, identifying LBAs from the prefetch request for which metadata pages are missing from the memory 210, and/or obtaining missing LBA metadata pages and writing the obtained LBA metadata pages to the memory 210.

Further, in some examples, the prefetch request obtained by the prefetch thread 232B is the requeued prefetch request that has been requeued by the prefetch thread 232A at 406. Alternatively, in other examples, the prefetch request obtained by the prefetch thread 232B is a different prefetch request than the requeued prefetch request that was requeued by the prefetch thread 232A at 406.

It should be understood that operations performed by the prefetch thread 232B at 408 and/or 410 are occurring in parallel with operations of the prefetch thread 232A at 406, 412, and/or 414. Further, in some examples, more or different prefetch threads are also operating in parallel with the prefetch thread 232A and/or prefetch thread 232B without departing from the description.

At 412, the prefetch thread 232A obtains the missing LBA metadata page and, at 414, the obtained LBA metadata page is cached to the memory 210. It should be understood that the operations performed at 412 and/or 414 are the same as the operations described above at least with respect to 310 and/or 312 of process 300 in FIG. 3. Further, in some examples, after the obtained LBA metadata page is cached to the memory 210, data stored in the memory 210 used to update an address map 224 and/or other metadata 222 during a bank flush as described herein.

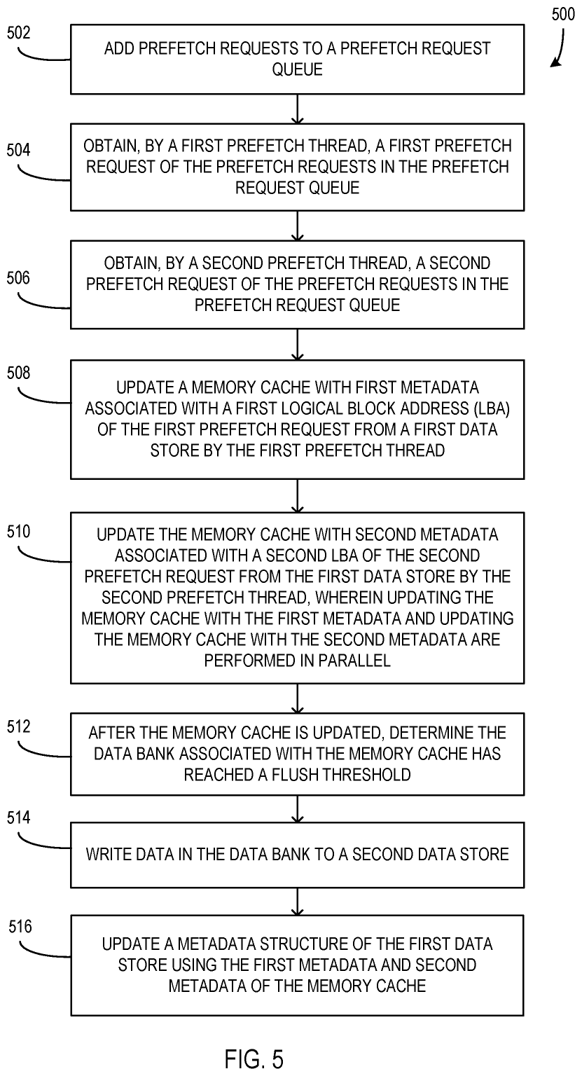

FIG. 5 is a flowchart illustrating a method 500 for storing data of write requests (e.g., write requests 202) in a multi-layer data store (e.g., data stores 208 and 212) using a prefetch module (e.g., prefetch module 226) and associated prefetch threads (e.g., prefetch threads 232). In some examples, the method 500 is executed or otherwise performed in a system such as systems 100 and/or 200 of FIGS. 1 and/or 2.

At 502, prefetch requests are added to a prefetch request queue. In some examples, a prefetch request is added to the prefetch request queue of a prefetch module based on the quantity of write requests in a coalesce list 216 or other data structure reaching a defined threshold. The prefetch requests includes LBA extents from write requests that are present in a coalesce list 216 when each prefetch request is generated, as described herein.

At 504, a first prefetch thread obtains a first prefetch request of the prefetch requests in the prefetch request queue. In some examples, the first prefetch thread is activated by a prefetch module to perform the prefetch operations as described herein. The first prefetch thread executes operations independently of and in parallel with other prefetch threads in the system to move metadata that will be used during a future bank flush operation to the memory cache.

At 506, a second prefetch thread obtains a second prefetch request of the prefetch requests in the prefetch request queue. In some examples, the second prefetch thread obtains the second prefetch request in parallel with the first prefetch thread obtaining the first prefetch request. Alternatively, or additionally, the second prefetch thread obtains the second prefetch request before or after the first prefetch thread obtains the first prefetch request and the first and second prefetch threads perform operations described herein simultaneously, even if the two threads are not synchronized or otherwise performing the same operations at the same time. For example, the second prefetch thread obtains the second prefetch request at the same time that the first prefetch thread is updating the memory cache at 508, as described below.

At 508, a memory cache of a data bank is updated with first metadata associated with a first LBA of the first prefetch request from a first data store by the first prefetch thread. In some examples, the first prefetch thread searches the memory cache for the presence of metadata associated with LBAs included in the first prefetch request. If, during the search, the first prefetch thread fails to find the metadata associated with the first LBA in the memory cache, the first prefetch thread is configured to update the memory cache with the first metadata associated with the first LBA from a first data store (e.g., the performance data store 208) as described herein. In some examples, updating the memory cache includes performing I/O operations with the first data store to obtain the metadata associated with the first LBA and then writing the obtained metadata to the memory cache in association with the first LBA, such that the first LBA and the associated metadata are present in the memory cache for use in a future bank flush operation.

At 510, the memory cache is updated with second metadata associated with a second LBA of the second prefetch request from the first data store by the second prefetch thread. The updating of the memory cache at 508 and at 510 are done in parallel by the first and second prefetch threads as described herein. In some examples, the updating of the memory cache with the second metadata by the second prefetch thread is performed in substantially the same way as the updating of the memory cache with the first metadata by the first prefetch thread described above.

Further, in some examples, the first prefetch thread determines that the first metadata associated with the first LBA extent is not present in the memory cache and removes the first LBA extent as described above from the first prefetch request to form a modified prefetch request. The first prefetch thread then adds the modified prefetch request back to the prefetch request queue, such that the modified prefetch request can be obtained and processed by another prefetch thread. The first prefetch thread then proceeds with updating the memory cache with the first metadata associated with the first LBA extent. Meanwhile, in some examples, the second prefetch thread obtains the modified prefetch request as the second prefetch request as described herein, such that the second prefetch thread begins processing the modified prefetch request and updates the memory cache with second metadata associated with a second LBA extent from that modified prefetch request.

At 512, after the memory cache is updated, it is determined that the data bank (e.g., bank 218) associated with the memory cache has reached a flush threshold. In some examples, the quantity of write requests and/or the quantity of data occupied by the write requests in the data bank are monitored and compared to the flush threshold (e.g., flush threshold 221). When the flush threshold is met or exceeded, a bank flush operation is triggered, resulting in the data stored in the data bank being written to the second data store (e.g., the log-structured data store 212) in a batch. Further, in some examples, the flush threshold 221 is based on a quantity of write requests (e.g., a threshold of 100 write requests), a quantity of data of the write requests (e.g., a threshold of 512 KB of data), and/or a percentage of a maximum capacity of the data bank (e.g., a threshold of 90% of the data bank occupied with write requests).

At 514, data in the data bank is written to a second data store. In some examples, the data flush operation includes writing the data stored in the data bank to the second data store (e.g., the log-structured data store 212). The performance of prefetch operations by the first and second prefetch threads as described herein improves the likelihood that all metadata associated with data to be written to the second data store during the bank flush operation is cached in the memory cache. However, in some examples, some portion of the metadata associated with data to be written during the bank flush operation is not present in the memory cache at the time of the bank flush operation. In such examples, the bank flush operation includes performing I/O operations to retrieve the metadata for use in updating the metadata of the first data store as part of the bank flush operation.

At 516, during the bank flush operation, a metadata structure associated with the data stored in the first and second data stores is updated based on the data that was written to the second data store using the cached metadata in the memory cache. For example, a metadata address map (e.g., address map 224) is updated to include mappings of LBAs of data blocks from the write requests associated with the first and second prefetch requests to physical block addresses (PBAs) of data blocks stored within the second data store. Additionally, or alternatively, more and/or different types of metadata are updated without departing from the description. After the bank flush is complete, the updated metadata structure of the first data store is used to determine the location of data stored in the second data store in order to read that data. For instance, when a data read request is received with an LBA of the data to be read, the LBA is used with the updated metadata structure (e.g., the address map 224) to determine the PBA of that data in the second data store and to retrieve the data from that PBA.

Further, in some examples, during or after the bank flush operation, the prefetch request queue is cleared of all prefetch requests associated with data written to the second data store and the memory cache is cleared of metadata associated with data that was written to the second data store during the bank flush operation.

Additionally, or alternatively, in some examples, the method 500 includes operations performed by a trained machine learning model. For example, a model that is trained to control how many prefetch threads are active based on current states of the system is used during the parallel operations of the first and second prefetch threads. Based on the current state of the first data store and/or the quantity of currently active prefetch threads, the model determines that the system should activate a third prefetch thread to more efficiently process the prefetch requests in the prefetch request queue. As a result of this determination, a third prefetch thread is activated and the third prefetch thread begins to obtain and process prefetch requests from the prefetch request queue in parallel with the first and second prefetch threads.

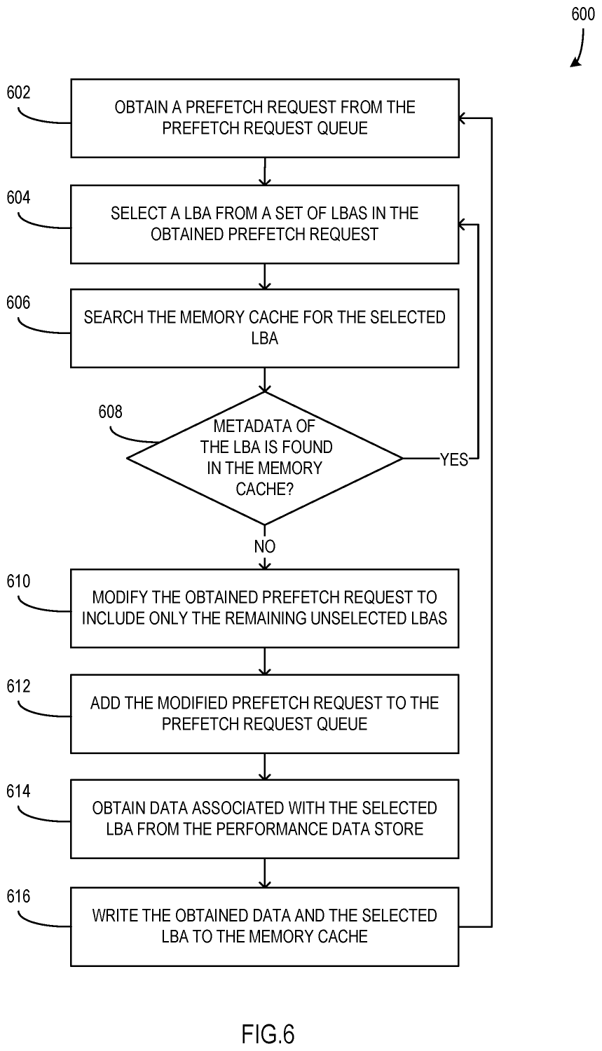

FIG. 6 is a flowchart illustrating a method 600 for prefetching data to a memory cache (e.g., memory 210) by a prefetch thread (e.g., prefetch thread 232). In some examples, the method 600 is performed as part of a method such as method 500 of FIG. 5. Further, in some examples, the method 600 is executed or otherwise performed in a system such as system 100 and/or 200 of FIGS. 1 and/or 2.

At 602, a prefetch thread obtains a prefetch request from the prefetch request queue. In some examples, the prefetch thread obtains the first prefetch request in the queue.

At 604, the prefetch thread selects an LBA from a set of LBAs in the obtained prefetch request. The obtained prefetch request includes the set of LBAs and/or data that is to be written to data blocks that are referenced by those LBAs. Thus, the selected LBA is a reference to a data block that will be written to based on the obtained prefetch request.

At 606, the memory cache associated with the data bank is searched for the selected LBA. If, at 608, all metadata associated with the selected LBA extent is found in the memory cache, the process returns to 604 to select another LBA extent from the obtained prefetch request. Alternatively, if metadata associated with the LBA extent is not found in the memory cache, the process proceeds to 610, where the obtained prefetch request is modified to include only the remaining unselected LBA extents of the originally obtained prefetch request. For example, the prefetch request includes four LBA extents: LBA 1, LBA 2, LBA 3, and LBA 4. The prefetch thread has found all metadata of LBA 1 in the memory cache already and fails to find a metadata page of LBA 2 in the memory cache. The prefetch thread then modifies the prefetch request to include only LBA 3 and LBA 4, as LBA 1 and the associated metadata are already present in the memory cache and the prefetch thread will update the memory cache to include LBA 2 and associated metadata during the rest of the described method 600.

At 612, the modified prefetch request is added to the prefetch request queue, such that another prefetch thread is enabled to obtain and process the remaining LBAs and/or LBA extents of the request in parallel with the prefetch thread updating the memory cache with the LBA and associated metadata that are missing therefrom.

At 614, metadata associated with the selected LBA is obtained from the performance data store. In some examples, the prefetch thread performs I/O operations to interact with the performance data store and obtain the metadata associated with the selected LBA (e.g., from the durable log 214 and/or metadata 222).

At 616, the obtained metadata associated with the selected LBA is written to the memory cache, such that an upcoming bank flush operation can use the written metadata and LBA to update metadata in response to data being written to the log-structure data store or other second data store as described herein. When this is complete, the prefetch thread returns to 602 to obtain another prefetch request from the prefetch request queue.

### Exemplary Operating Environment

The present disclosure is operable with a computing apparatus according to an embodiment as a functional block diagram 700 in FIG. 7. In an example, components of a computing apparatus 718 are implemented as a part of an electronic device according to one or more embodiments described in this specification. The computing apparatus 718 comprises one or more processors 719 which may be microprocessors, controllers, or any other suitable type of processors for processing computer executable instructions to control the operation of the electronic device. Alternatively, or in addition, the processor 719 is any technology capable of executing logic or instructions, such as a hard-coded machine. In some examples, platform software comprising an operating system 720 or any other suitable platform software is provided on the apparatus 718 to enable application software 721 to be executed on the device. In some examples, updating a memory cache using a prefetch module and associated prefetch threads as described herein is accomplished by software, hardware, and/or firmware.

In some examples, computer executable instructions are provided using any computer-readable media that are accessible by the computing apparatus 718. Computer-readable media include, for example, computer storage media such as a memory 722 and communications media. Computer storage media, such as a memory 722, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 722) is shown within the computing apparatus 718, it will be appreciated by a person skilled in the art, that, in some examples, the storage is distributed or located remotely and accessed via a network or other communication link (e.g., using a communication interface 723).

Further, in some examples, the computing apparatus 718 comprises an input/output controller 724 configured to output information to one or more output devices 725, for example a display or a speaker, which are separate from or integral to the electronic device. Additionally, or alternatively, the input/output controller 724 is configured to receive and process an input from one or more input devices 726, for example, a keyboard, a microphone, or a touchpad. In one example, the output device 725 also acts as the input device. An example of such a device is a touch sensitive display. The input/output controller 724 may also output data to devices other than the output device, e.g., a locally connected printing device. In some examples, a user provides input to the input device(s) 726 and/or receive output from the output device(s) 725.

The functionality described herein can be performed, at least in part, by one or more hardware logic components. According to an embodiment, the computing apparatus 718 is configured by the program code when executed by the processor 719 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises: a processor; and a memory comprising computer program code, the memory and the computer program code configured to cause the processor to: add prefetch requests to a prefetch request queue; obtain, by a first prefetch thread, a first prefetch request of the prefetch requests in the prefetch request queue; obtain, by a second prefetch thread, a second prefetch request of the prefetch requests in the prefetch request queue; update a memory cache with first metadata associated with a first logical block address (LBA) of the first prefetch request from a first data store by the first prefetch thread; update the memory cache with second metadata associated with a second LBA of the second prefetch request from the first data store by the second prefetch thread, wherein updating the memory cache with the first metadata and updating the memory cache with the second metadata are performed in parallel; determine a data bank associated with the memory cache has reached a flush threshold; write data in the data bank associated with the first prefetch request and the second prefetch request to a second data store; and update a metadata structure of the first data store using the first metadata and second metadata, wherein the updated metadata structure of the first data store indicates data locations in the second data store to which the data associated with the first prefetch request and the second prefetch request is written.

An example computerized method comprises: adding prefetch requests to a prefetch request queue; obtaining, by a first prefetch thread, a first prefetch request of the prefetch requests in the prefetch request queue; obtaining, by a second prefetch thread, a second prefetch request of the prefetch requests in the prefetch request queue; updating a memory cache with first metadata associated with a first logical block address (LBA) of the first prefetch request from a first data store by the first prefetch thread; updating the memory cache with second metadata associated with a second LBA of the second prefetch request from the first data store by the second prefetch thread, wherein updating the memory cache with the first metadata and updating the memory cache with the second metadata are performed in parallel; determining a data bank associated with the memory cache has reached a flush threshold; writing data in the data bank associated with the first prefetch request and the second prefetch request to a second data store; and updating a metadata structure of the first data store using the first metadata and second metadata, wherein the updated metadata structure of the first data store indicates data locations in the second data store to which the data associated with the first prefetch request and the second prefetch request is written.

One or more computer storage media have computer-executable instructions that, upon execution by a processor, cause the processor to at least: add prefetch requests to a prefetch request queue; obtain, by a first prefetch thread, a first prefetch request of the prefetch requests in the prefetch request queue; obtain, by a second prefetch thread, a second prefetch request of the prefetch requests in the prefetch request queue; update a memory cache with first metadata associated with a first logical block address (LBA) of the first prefetch request from a first data store by the first prefetch thread; update the memory cache with second metadata associated with a second LBA of the second prefetch request from the first data store by the second prefetch thread, wherein updating the memory cache with the first metadata and updating the memory cache with the second metadata are performed in parallel; determine a data bank associated with the memory cache has reached a flush threshold; and write data in the data bank to a second data store; and update a metadata structure of the first data store using the first metadata and second metadata, wherein the updated metadata structure of the first data store indicates data locations in the second data store to which the data associated with the first prefetch request and the second prefetch request is written.

Alternatively, or in addition to the other examples described herein, examples include any combination of the following:
further comprising: identifying, by the first prefetch thread, that the first metadata associated with the first LBA is missing in the memory cache, wherein updating the memory cache with the first metadata is based on identifying that the first metadata is missing in the memory cache; and identifying, by the second prefetch thread, that the second metadata associated with the second LBA is missing in the memory cache, wherein updating the memory cache with the second metadata is based on identifying that the second metadata is missing in the memory cache.
further comprising: removing, by the first prefetch thread, the first LBA from the first prefetch request to form a modified prefetch request; and adding, by the first prefetch thread, the modified prefetch request to the prefetch request queue prior to updating the memory cache of the data bank with the first metadata; wherein obtaining the second prefetch request by the second prefetch thread includes obtaining the modified prefetch request added to the prefetch request queue by the first prefetch thread.
wherein updating the metadata structure of the first data store includes: updating a metadata address map with the first metadata and the second metadata after writing the data in the data bank to the second data store, wherein the metadata address map includes mappings of LBAs of data blocks to physical block addresses (PBAs) of data blocks within the second data store.
further comprising: clearing the prefetch request queue of prefetch requests associated with data written to the second data store after writing the data in the data bank to the second data store; and clearing the memory cache of metadata associated with data that has been written to the second data store after writing the data in the data bank to the second data store.
further comprising: activating a third prefetch thread based on analysis of a current state of the first data store and a current quantity of active prefetch threads using a trained machine learning model.
wherein the second data store is a log-structured data store and writing data in the data bank to the second data store includes performing a full stripe write to the second data store.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for adding prefetch requests to a prefetch request queue; exemplary means for obtaining, by a first prefetch thread, a first prefetch request of the prefetch requests in the prefetch request queue; exemplary means for obtaining, by a second prefetch thread, a second prefetch request of the prefetch requests in the prefetch request queue; exemplary means for updating a memory cache with first metadata associated with a first logical block address (LBA) of the first prefetch request from a first data store by the first prefetch thread; exemplary means for updating the memory cache with second metadata associated with a second LBA of the second prefetch request from the first data store by the second prefetch thread, wherein updating the memory cache with the first metadata and updating the memory cache with the second metadata are performed in parallel; exemplary means for determining a data bank associated with the memory cache has reached a flush threshold; exemplary means for writing data in the data bank to a second data store; and exemplary means for updating a metadata structure of the first data store using the first metadata and second metadata, wherein the updated metadata structure of the first data store indicates data locations in the second data store to which the data associated with the first prefetch request and the second prefetch request is written.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a memory comprising computer program code, the memory and the computer program code configured to cause the processor to:
add prefetch requests to a prefetch request queue;
obtain, by a first prefetch thread, a first prefetch request of the prefetch requests in the prefetch request queue;
obtain, by a second prefetch thread, a second prefetch request of the prefetch requests in the prefetch request queue;
update a memory cache with first metadata associated with a first logical block address (LBA) of the first prefetch request from a first data store by the first prefetch thread;
update the memory cache with second metadata associated with a second LBA of the second prefetch request from the first data store by the second prefetch thread, wherein updating the memory cache with the first metadata and updating the memory cache with the second metadata are performed in parallel;
determine a data bank associated with the memory cache has reached a flush threshold;
write data in the data bank associated with the first prefetch request and the second prefetch request to a second data store; and
update a metadata structure of the first data store using the first metadata and second metadata in the updated memory cache, wherein the updated metadata structure of the first data store indicates data locations in the second data store to which the data associated with the first prefetch request and the second prefetch request is written.

2. The system of claim 1, wherein the memory and the computer program code are configured to further cause the processor to:
identify, by the first prefetch thread, that the first metadata associated with the first LBA is missing in the memory cache, wherein updating the memory cache with the first metadata is based on identifying that the first metadata is missing in the memory cache; and
identify, by the second prefetch thread, that the second metadata associated with the second LBA is missing in the memory cache, wherein updating the memory cache with the second metadata is based on identifying that the second metadata is missing in the memory cache.

3. The system of claim 2, wherein the memory and the computer program code are configured to further cause the processor to:
remove, by the first prefetch thread, the first LBA from the first prefetch request to form a modified prefetch request; and
add, by the first prefetch thread, the modified prefetch request to the prefetch request queue prior to updating the memory cache of the data bank with the first metadata;
wherein obtaining the second prefetch request by the second prefetch thread includes obtaining the modified prefetch request added to the prefetch request queue by the first prefetch thread.

4. The system of claim 1, wherein updating the metadata structure of the first data store includes:
updating a metadata address map with the first metadata and the second metadata after writing the data in the data bank to the second data store, wherein the metadata address map includes mappings of LBAs of data blocks to physical block addresses (PBAs) of data blocks within the second data store.

5. The system of claim 1, wherein the memory and the computer program code are configured to further cause the processor to:
clear the prefetch request queue of prefetch requests associated with data written to the second data store after writing the data in the data bank to the second data store; and
clear the memory cache of metadata associated with data that has been written to the second data store after writing the data in the data bank to the second data store.

6. The system of claim 1, wherein the memory and the computer program code are configured to further cause the processor to:
activate a third prefetch thread based on analysis of a current state of the first data store and a current quantity of active prefetch threads using a trained machine learning model.

7. The system of claim 1, wherein the second data store is a log-structured data store and writing data in the data bank to the second data store includes performing a full stripe write to the second data store.

8. A computerized method comprising:
adding prefetch requests to a prefetch request queue;
obtaining, by a first prefetch thread, a first prefetch request of the prefetch requests in the prefetch request queue;
obtaining, by a second prefetch thread, a second prefetch request of the prefetch requests in the prefetch request queue;
updating a memory cache with first metadata associated with a first logical block address (LBA) of the first prefetch request from a first data store by the first prefetch thread;
updating the memory cache with second metadata associated with a second LBA of the second prefetch request from the first data store by the second prefetch thread, wherein updating the memory cache with the first metadata and updating the memory cache with the second metadata are performed in parallel;
determining a data bank associated with the memory cache has reached a flush threshold;
writing data in the data bank associated with the first prefetch request and the second prefetch request to a second data store; and
updating a metadata structure of the first data store using the first metadata and second metadata in the updated memory cache, wherein the updated metadata structure of the first data store indicates data locations in the second data store to which the data associated with the first prefetch request and the second prefetch request is written.

9. The computerized method of claim 8, further comprising:
identifying, by the first prefetch thread, that the first metadata associated with the first LBA is missing in the memory cache, wherein updating the memory cache with the first metadata is based on identifying that the first metadata is missing in the memory cache; and
identifying, by the second prefetch thread, that the second metadata associated with the second LBA is missing in the memory cache, wherein updating the memory cache with the second metadata is based on identifying that the second metadata is missing in the memory cache.

10. The computerized method of claim 9, further comprising:
removing, by the first prefetch thread, the first LBA from the first prefetch request to form a modified prefetch request; and
adding, by the first prefetch thread, the modified prefetch request to the prefetch request queue prior to updating the memory cache of the data bank with the first metadata;
wherein obtaining the second prefetch request by the second prefetch thread includes obtaining the modified prefetch request added to the prefetch request queue by the first prefetch thread.

11. The computerized method of claim 8, wherein updating the metadata structure of the first data store includes:
updating a metadata address map with the first metadata and the second metadata after writing the data in the data bank to the second data store, wherein the metadata address map includes mappings of LBAs of data blocks to physical block addresses (PBAs) of data blocks within the second data store.

12. The computerized method of claim 8, further comprising:
clearing the prefetch request queue of prefetch requests associated with data written to the second data store after writing the data in the data bank to the second data store; and
clearing the memory cache of metadata associated with data that has been written to the second data store after writing the data in the data bank to the second data store.

13. The computerized method of claim 8, further comprising:
activating a third prefetch thread based on analysis of a current state of the first data store and a current quantity of active prefetch threads using a trained machine learning model.

14. The computerized method of claim 8, wherein the second data store is a log-structured data store and writing data in the data bank to the second data store includes performing a full stripe write to the second data store.

15. One or more computer storage media having computer-executable instructions that, upon execution by a processor, cause the processor to at least:
add prefetch requests to a prefetch request queue;
obtain, by a first prefetch thread, a first prefetch request of the prefetch requests in the prefetch request queue;
obtain, by a second prefetch thread, a second prefetch request of the prefetch requests in the prefetch request queue;
update a memory cache with first metadata associated with a first logical block address (LBA) of the first prefetch request from a first data store by the first prefetch thread;
update the memory cache with second metadata associated with a second LBA of the second prefetch request from the first data store by the second prefetch thread, wherein updating the memory cache with the first metadata and updating the memory cache with the second metadata are performed in parallel;
determine a data bank associated with the memory cache has reached a flush threshold; and
write data in the data bank to a second data store; and
update a metadata structure of the first data store using the first metadata and second metadata in the updated memory cache, wherein the updated metadata structure of the first data store indicates data locations in the second data store to which the data associated with the first prefetch request and the second prefetch request is written.

16. The computer storage media of claim 15, wherein the computer-executable instructions, upon execution by the processor, further cause the processor to at least:
identify, by the first prefetch thread, that the first metadata associated with the first LBA is missing in the memory cache, wherein updating the memory cache with the first metadata is based on identifying that the first metadata is missing in the memory cache; and
identify, by the second prefetch thread, that the second metadata associated with the second LBA is missing in the memory cache, wherein updating the memory cache with the second metadata is based on identifying that the second metadata is missing in the memory cache.

17. The computer storage media of claim 16, wherein the computer-executable instructions, upon execution by the processor, further cause the processor to at least:
remove, by the first prefetch thread, the first LBA from the first prefetch request to form a modified prefetch request; and
add, by the first prefetch thread, the modified prefetch request to the prefetch request queue prior to updating the memory cache of the data bank with the first metadata;
wherein obtaining the second prefetch request by the second prefetch thread includes obtaining the modified prefetch request added to the prefetch request queue by the first prefetch thread.

18. The computer storage media of claim 15, wherein updating the metadata structure of the first data store includes:
updating a metadata address map with the first metadata and the second metadata after writing the data in the data bank to the second data store, wherein the metadata address map includes mappings of LBAs of data blocks to physical block addresses (PBAs) of data blocks within the second data store.

19. The computer storage media of claim 15, wherein the computer-executable instructions, upon execution by the processor, further cause the processor to at least:
clear the prefetch request queue of prefetch requests associated with data written to the second data store after writing the data in the data bank to the second data store; and
clear the memory cache of metadata associated with data that has been written to the second data store after writing the data in the data bank to the second data store.

20. The computer storage media of claim 15, wherein the computer-executable instructions, upon execution by the processor, further cause the processor to at least:
activate a third prefetch thread based on analysis of a current state of the first data store and a current quantity of active prefetch threads using a trained machine learning model.
